(19) United States
(12) Patent Application Publication
(10) Pub. No.: US 2019/0182418 A1
(43) Pub. Date: Jun. 13, 2019

(54) Grouped Photography Studio Lighting System with Software Driven and Simultaneous Wireless Dimming Control and Related Photography System

(71) Applicant: Peng-Cheng Lai, Los Altos, CA (US)

(72) Inventor: Peng-Cheng Lai, Los Altos, CA (US)

(21) Appl. No.: 15/834,988

(22) Filed: Dec. 7, 2017

(51) Int. Cl. H04N 5/232; H04N 5/225; H04N 5/235; G03B 15/02

(52) U.S. Cl. CPC H04N 5/23206; H04N 5/2256; H04N 5/23222; H04N 9/735; H04N 5/23293; H04N 5/23219; G03B 15/02; H04N 5/2354

(57) ABSTRACT

A grouped photography studio lighting system with software-driven and simultaneous wireless dimming control comprises a wireless remote controller, a computer and several studio lights. The computer includes a software for controlling the wireless remote controller to transmit wireless signal. Each studio light has a receiver for receiving the wireless signal and lights an object according to the wireless signal. The wireless remote controller can switch on or increase a parameter of some studio lights and switch off or decrease the parameter of other studio lights simultaneously when a control mark is under a planar control. The grouped photography studio lighting system can further be used with a photography device and/or a sensor. The photography device is controlled by the computer via a wire or wireless signal. The sensor connects the computer via a wire or wireless signal, and each studio light is controlled according to the sensor detection.

### FIELD OF THE INVENTION

The present invention relates to a studio lighting system and a photography system, and more particularly to a grouped photography studio lighting system with software-driven and simultaneous wireless dimming control and a related photography system.

### DESCRIPTION OF THE RELATED ART

It is difficult to take nice pictures or record video well in week light without properly filling light to the object to be photographed. Thus, in order to obtain high quality images, it is necessary to choose a proper lamp for stably lighting the object according to the surrounding light during photographing.

The commercially available studio light briefly includes traditional manual control type and remote control type. The former one generally can be switched on/off by directly pressing the button or toggling the switch only. In contrast, the latter one generally includes a remote controller to enable the studio light to be switched on/off within a restricted distance, and thus more convenient in use. In recent years, some newer studio lights use LED (light emitting diode) as the light source and lead to the brightness of the studio light become dimmable in manual or by using the remote controller. In addition, for some newer studio lights, it is also possible to use a single remote controller to simultaneously remote control a plurality of studio lights for switching on, switching off and dimming brightness by presetting a plurality of studio lights into the same group.

However, the traditional remote controller can only remote control a single one of or a single group of studio lights at a time and is unable to remote control a plurality of lights preset into different groups. Further, just like the conventional TV remote controller, such a remote controller can only increase or decrease a little brightness of the studio light by pressing the button once. As a result, for dimming the brightness of the studio light by using the traditional remote controller, it is not only spent more times, but also difficult to accurately obtain the required brightness.

### SUMMARY OF THE INVENTION

The present invention is directed to a grouped photography studio lighting system with software-driven and simultaneous wireless dimming control, wherein its computer can remote control the studio light by using a wireless signal.

The present invention is also directed to a photography system, wherein its computer not only can remote control the studio light by using a wireless signal, but also can control the photography device via a wire signal or a wireless signal.

The present invention is yet directed to a studio lighting system, wherein its computer not only can remote control the studio light by using a wireless signal, but also can connect the sensor via a wire signal or a wireless signal and control the studio light according to at least one of sounds, voices, speeches, motions, facial expressions and gestures detected by the sensor.

The present invention provides a grouped photography studio lighting system with software-driven and simultaneous wireless dimming control, that comprises a wireless remote controller, a computer and a plurality of studio lights. The computer includes a software for controlling the wireless remote controller to transmit at least a wireless signal. Each of the studio lights has a receiver for receiving the wireless signal and is capable of lighting an object to be photographed according to the wireless signal. The wireless remote controller can switch on or increase a parameter of at least one or at least a group of the studio lights and switch off or decrease the parameter of at least another one or at least another group of the studio lights simultaneously when a control mark on a screen of the computer is under a planar control.

According to an embodiment of the present invention, the wireless remote controller is built in or outside the computer.

According to an embodiment of the present invention, the computer is a desktop, a laptop, a tablet or a smartphone.

According to an embodiment of the present invention, the wireless signal is radio frequency signal, Wi-Fi signal or Bluetooth signal and broadcasted by the wireless remote controller.

According to an embodiment of the present invention, the parameter is brightness or color temperature.

According to an embodiment of the present invention, each of the studio lights is a photo light or a video light.

According to an embodiment of the present invention, the planar control comprises at least one of touching, pressing, track bar sliding, clicking, keying in and cursor dragging by using an input device.

According to an embodiment of the present invention, the input device comprises a keyboard, a mouse, a touch screen, a touchpad, a tablet or a smartphone.

According to an embodiment of the present invention, each one of the studio lights is preset into at least a group of front light, back light, rear light, side light, top light and bottom light for lighting the object to be photographed from different directions.

The present invention also provides a photography system comprising the grouped photography studio lighting system with software-driven and simultaneous wireless dimming control mentioned above and at least a photography device, wherein the photography device is controlled by the computer via a wire signal or a wireless signal and can provide a real-time preview image on the screen.

According to an embodiment of the present invention, the photography device is a camera, a video recorder, a smartphone or a tablet.

According to an embodiment of the present invention, a number of the photography device is plural, and the computer simultaneously controls the photography devices via a wire signal or a wireless signal.

According to an embodiment of the present invention, the photography system further comprises a sensor, wherein the computer connects the sensor via a wire signal or a wireless signal, and controls the photography device according to at least one of sounds, voices, speeches, motions, facial expressions and gestures detected by the sensor.

The present invention further provides a photography system comprising the grouped photography studio lighting system with software-driven and simultaneous wireless dimming control mentioned above and at least a sensor, wherein the sensor connects the computer via a wire signal or a wireless signal, and each of the studio lights is controlled according to at least one of sounds, voices, speeches, motions, facial expressions and gestures detected by the sensor.

According to an embodiment of the present invention, the sensor is a sound sensor, a speech recognizer, a motion sensor, an image sensor or an image recognizer.

Accordingly, the grouped photography studio lighting system provided in the present invention uses a computer to transmit a wireless signal to remote control the studio light. As a result, it is possible to remote control the studio light in a continuous remote control manner by clicking or dragging the mouse cursor. In addition, comparing to using a traditional remote controller, the present invention is quicker and more accurate. Moreover, in the prior art, the traditional remote controller can only control a single studio light or simultaneously control a plurality of studio lights preset into the same group. In contrast, in the present invention, it is possible to not only switch on, switch off, and increase or decrease the brightness and/or the color temperature of different groups of the studio lights simultaneously, but also switch on or increase the brightness and/or the color temperature of part of the studio lights when switching off or decreasing the brightness and/or the color temperature of another part of the studio lights simultaneously.

Besides, the computer can also simultaneously control a plurality of photography devices to shoot the object to be photographed from different shooting angles via a wired or wireless signal. Moreover, other than clicking, cursor dragging and track bar sliding with a mouse or keying in with a keyboard, it is also possible to remote control the studio light or the photography device by touching or pressing a touch screen, a touchpad, a tablet, a smartphone connecting the computer, or detecting voices, sounds, speeches, motions, facial expressions, gestures with a sensor.

### BRIEF DESCRIPTION OF THE DRAWINGS

FIG. 1 illustrates a block diagram of a grouped photography studio lighting system with software-driven and simultaneous wireless dimming control according to an embodiment of the present invention.

FIG. 2 and FIG. 3 illustrate structural schematic views of two different kinds of studio lights as shown in FIG. 1, wherein FIG. 2 represents a photo light and FIG. 3 represents a video light.

FIG. 4 illustrates a block diagram of a photography system according to another embodiment of the present invention.

FIG. 5 illustrates a schematic view of shooting a cabinet by the photography system as shown in FIG. 4.

FIG. 6 and FIG. 7 illustrate schematic views of different preview screens represented in a screen of the computer when shooting the cabinet by the photography system as shown in FIG. 5.

FIG. 8 and FIG. 9 illustrate schematic views of a preview screen by using a photography system with 6 light groups to shoot the cabinet as shown in FIG. 5.

FIG. 10 illustrates a block diagram of a photography system according to another embodiment of the present invention.

FIG. 11 illustrates a schematic view of shooting a cabinet by the photography system as shown in FIG. 10.

### DETAILED DESCRIPTION OF THE INVENTION

Reference will now be made in detail to specific embodiments of the present invention. Examples of these embodiments are illustrated in the accompanying drawings. While the invention will be described in conjunction with these specific embodiments, it will be understood that it is not intended to limit the invention to these embodiments. In fact, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well-known process operations are not described in detail in order not to obscure the present invention. Besides, in all of the following embodiments, the same or similar components illustrated in different embodiments refer to the same symbols.

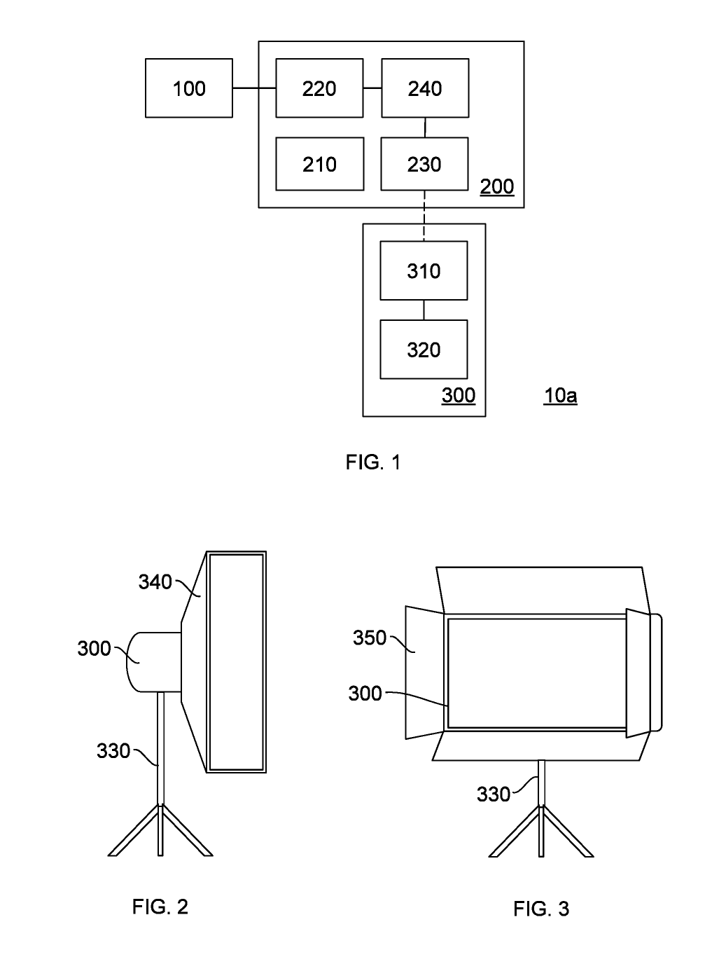

FIG. 1 illustrates a block diagram of a grouped photography studio lighting system with software-driven and simultaneous wireless dimming control according to an embodiment of the present invention. FIG. 2 and FIG. 3 illustrate structural schematic views of two different kinds of studio lights as shown in FIG. 1, wherein FIG. 2 represents a photo light and FIG. 3 represents a video light. Referring to FIG. 1, the studio light 10a comprises a computer 100, a wireless remote controller 200 and at least a studio light 300. In the present embodiment, for example but not limited to, the computer 100 is a desktop, and the wireless remote controller 200 is located outside the computer 100 and connects the computer 100 via a USB cable, so as to enable the computer 100 to control the wireless remote controller 200 by a wire signal via the USB cable for transmitting a wireless signal, wherein the wireless signal can be a radio frequency signal. In other embodiments, the wireless remote controller 200 can connect the computer 100 via an Ethernet cable or other cables for wire signal transmission. In addition, the computer 100 can further be a laptop, a tablet or a smartphone, while the wireless remote controller 200 can further be a wireless network card built in the computer 100 for transmitting a Wi-Fi signal or a Bluetooth signal. Moreover, the studio light 300 has a receiver 310 for receiving the wireless signal transmitted by the wireless remote controller 200 and then lights an object to be photographed according to the wireless signal. As a result, it is possible to use the computer 100 to remote control the studio light 300 for properly lighting the object to be photographed according to the shooting environment and lighting requirement.

In detail, as shown in FIG. 1, the wireless remote controller 200 can include a power supply 210, a USB chip 220, a wireless signal emitter 230 and a MCU (microprocessing control unit) 240 electrically connected between the USB chip 220 and the wireless signal emitter 230. For an example but not limited to, the power supply 210 can be powered by a socket or an external power source via a power cable (not shown), while the USB chip 220 can connect the computer 100 via a USB cable. Furthermore, the studio light 300 can has a receiver 310 and a LED module 320 and is, for example but not limited to, a photo light for taking pictures or a video light for recording videos.

In the present embodiment, the computer 100 transmits a control signal to the USB chip 220 via the USB cable. Thereafter, the MCU 240 receives the control signal via the USB chip 220 and then controls the wireless signal emitter 230 to transmit a wireless signal including the control signal. Afterward, the studio light 300 receives the wireless signal via the receiver 310 and then control the LED module 320 according to the control signal, so as to enable the LED module 320 to be remote controlled by the computer 100 for turning on, turning off, brightness dimming and/or color temperature adjustment. As a result, it is possible to light the object to be photographed properly according to the shooting environment and lighting requirement. Comparing to a traditional remote controller for the studio light in the prior art, the present invention using a computer to remote control the studio light is not only quicker and more accurate, but also possible to dim the brightness or adjust the color temperature with a continuous remote control manner, such as sliding a track bar, dragging the mouse cursor or directly keying in the value with a keyboard.

In the present embodiments, the studio light 300 can be a photo light for taking pictures as shown in FIG. 2, which can be secured on a tripod 330 and a softbox 340 can be added in front of the LED module 320 to enable the light to be more uniform. Alternatively, the studio light 300 can also be a video light for recording videos as shown in FIG. 3, which can also be secured on a tripod 330 and a plurality of flaps 350 can be added around the LED module 320 to enable the light to concentrate toward the object to be photographed.

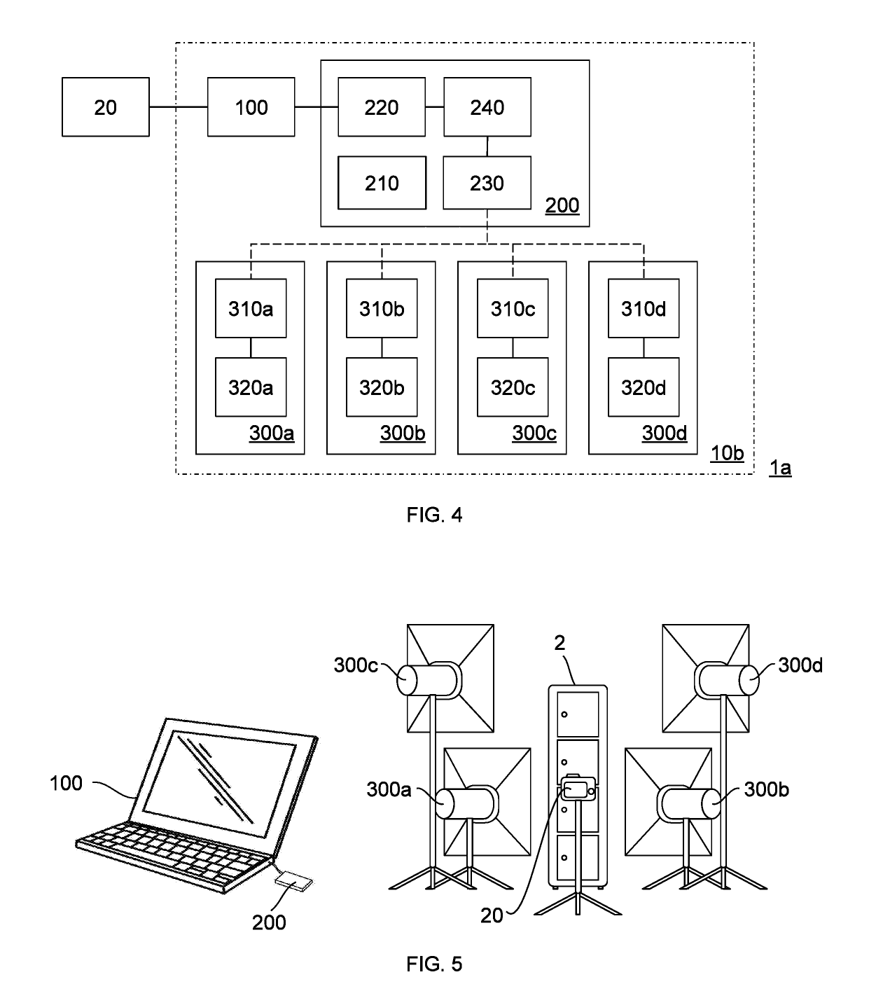

FIG. 4 illustrates a block diagram of a photography system according to another embodiment of the present invention, and FIG. 5 illustrates a schematic view of shooting a cabinet by the photography system as shown in FIG. 4. Referring to FIG. 4 and FIG. 5, the photography system 1a is composed of the studio lighting system 10b and a photography device 20. Herein, the studio lighting system 10b is similar to the studio lighting system 10a in the previous embodiment, except that the studio lighting system 10b includes 4 studio lights 300a, 300b, 300c, 300d and the wireless remote controller 200 broadcasts the wireless signal, so as to enable the studio lights 300a, 300b, 300c, 300d simultaneously to receive the wireless signal and be remote controlled by the computer 100. However, in other embodiments, the wireless remote controller 200 can also transmit a plurality of wireless signals in a significant short term for enabling the studio lights 300a, 300b, 300c, 300d to be substantially remote controlled by the computer 100 at the same time. Furthermore, for example but not limited to, the photography device 20 can be a camera, a video recorder, a smartphone or a tablet, which can be controlled by the computer 100 to take pictures or record videos of a cabinet 2 with a wire signal via a USB cable and can provide a real-time preview image on the screen. However, in other non-illustrated embodiments, the photography device can be controlled by a computer to take pictures or record videos of the cabinet with a wireless signal as well.

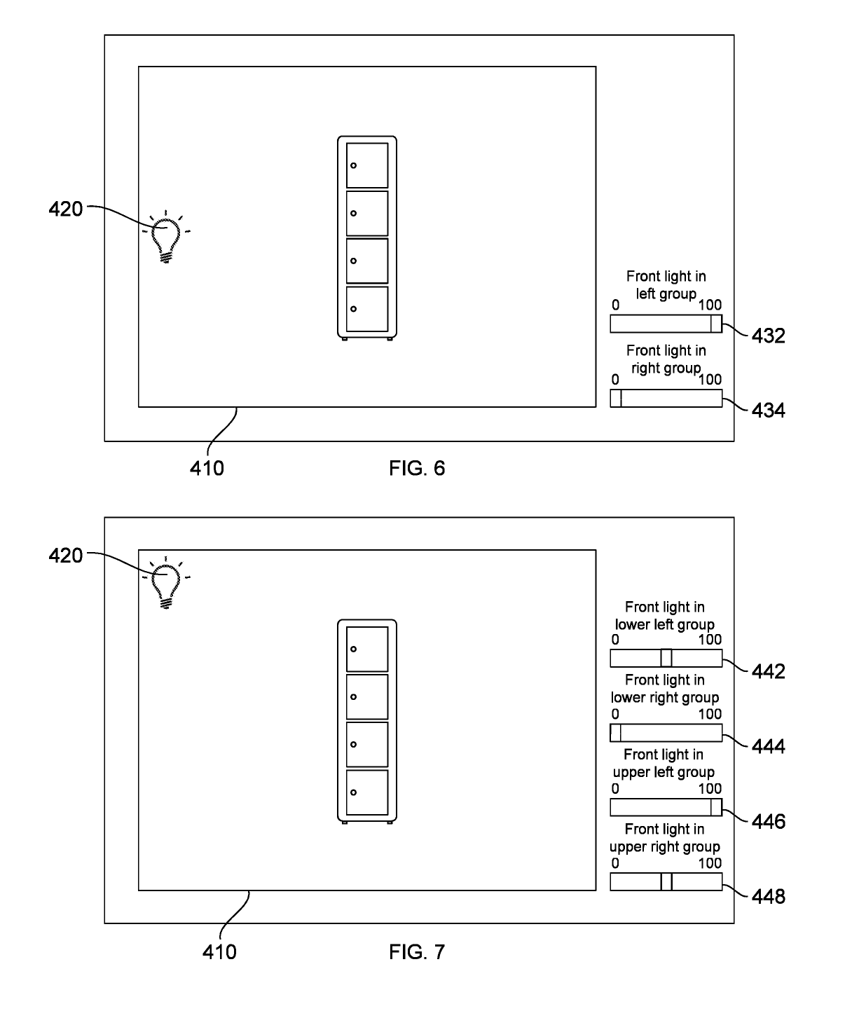

FIG. 6 and FIG. 7 illustrate schematic views of different preview screens represented in a screen of the computer 100 when shooting the cabinet 2 by the photography system as shown in FIG. 5. In detail, in an example of the present embodiment as shown in FIG. 5 and FIG. 6, the studio lights 300a, 300b, 300c, 300d are disposed at the left side and the right side in front of the cabinet 2 for respectively lighting the front of the cabinet 2 from the lower left, lower right, upper left and upper right sides. In such a case, the studio lights 300a, 300c can be preset as a front light in left group, and the studio lights 300b, 300d can be preset as a front light in right group. Accordingly, it is possible to slide the track bar 432 for the front light in left group to remote control the brightness of the studio lights 300a, 300c or slide the track bar 434 for the front light in right group to remote control the brightness of the studio lights 300b, 300d by dragging the mouse cursor on the screen of the computer 100. Moreover, it is also possible to slide a control mark, i.e. the bulb icon 420, on a preview screen 410 of the screen of the computer 100 to simultaneously remote control the brightness of all of the studio lights 300a, 300b, 300c, 300d by dragging the mouse cursor. For example, when the bulb icon 420 is under a planar control, for example slid to the most left side of the preview screen 410, the track bar 432 for the front light in left group is slid to the left end and the brightness value of the studio lights 300a, 300c will be 0 (turned off), and the track bar 434 for the front light in right group is slid to the right end and the brightness value of the studio lights 300b, 300d will be 100 (maximum) simultaneously. Therefore, the left side of the cabinet 2 will be brighter while the right side will be darker and probably have a shadow.

Further, referring to FIG. 5 and FIG. 7, in another embodiment, the studio lights 300a, 300b, 300c, 300d can be respectively preset as a front light in lower left, lower right, upper left, upper right groups. Accordingly, it is possible to respectively slide the track bars 442, 444, 446, 448 for the front light in lower left, lower right, upper left, upper right groups to remote control the brightness of the studio lights 300a, 300b, 300c, 300d by dragging the mouse cursor on the screen of the computer 100. Similarly, as shown in FIG. 7, it is also possible to slide the bulb icon 420 to the upper left corner of the preview screen 410 to simultaneously remote control the brightness of all of the studio lights 300a, 300b, 300c, 300d by dragging the mouse cursor. In such a case, the track bars 442, 448 for the front light in lower left and upper right groups are both slid to the middle point and the brightness value of the studio lights 300a, 300d will be 50 (middle) simultaneously. In addition, the track bar 444 for the front light in lower right group is slid to the left end and the brightness value of the studio lights 300b will be 0 (turned off) simultaneously. At the same time, the track bar 446 for the front light in upper left group is slid to the right end and the brightness value of the studio lights 300c will be 100 (maximum) simultaneously. Similarly, the upper left corner of the cabinet 2 will be brighter while the lower right corner will be darker and probably have a shadow.

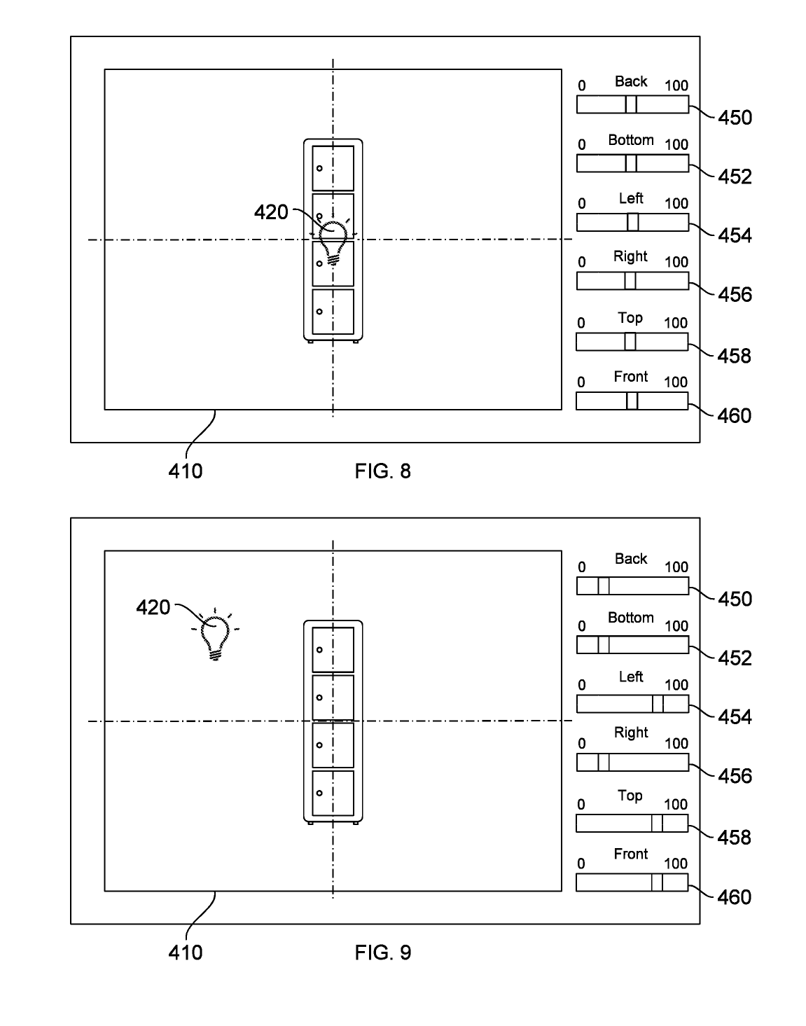

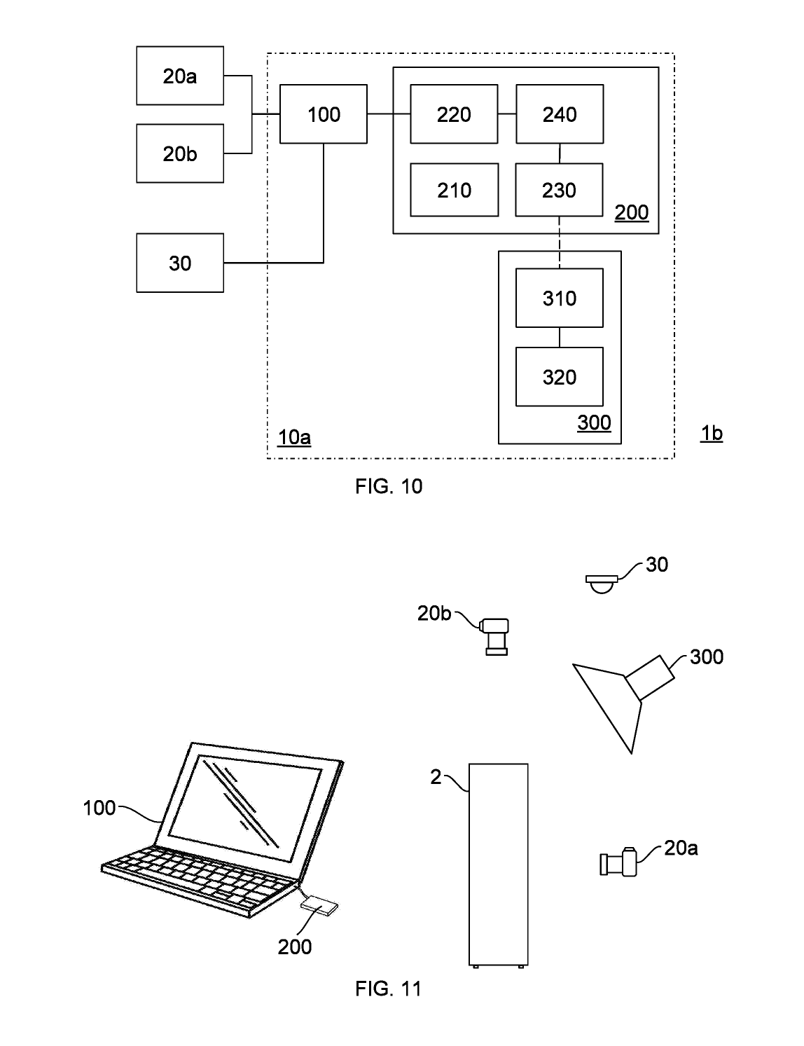

FIG. 8 and FIG. 9 illustrate schematic views of a preview screen by using a photography system with 6 light groups to shoot the cabinet as shown in FIG. 5, wherein FIG. 8 represents that the initial values of the track bars are all preset into median, and FIG. 9 represents that the values of the track bars are all adjusted according to the location of the control mark related to the preview screen. Referring to FIG. 8 and FIG. 9, in the present embodiment, the 6 studio lights are respectively preset into the back, bottom, left, right, top and front light groups and the initial values thereof are all preset into median as shown in FIG. 8. In another word, when a brightness dimming function of the software is launched, the bulb icon 420 and the values of the 6 track bars can be all back to median. When the bulb icon 420 is slid to the center of the second quadrant of the preview screen as shown in FIG. 9, all of the track bar 454 for the left light group, the track bar 458 for the top light group and the track bar 460 for the front light group are slid rightward, and the brightness will be simultaneously increased, for example, the values are all dimmed to about 75 automatically. At the same time, all of the track bar 450 for the back light group, the track bar 452 for the bottom light group and the track bar 456 for the right light group are slid leftward, and the brightness will be simultaneously decreased, for example, the values are all dimmed to about 25 automatically. In a word, no matter where the bulb icon 420 is slid to, the brightness will be simultaneously dimmed and the track bars 450, 452, 454, 456, 458, 460 will be automatically slid accordingly.

It should be noted that although the above-mentioned embodiments are all disclosed in remote controlling the studio lights 300a, 300b, 300c, 300d by dragging the mouse cursor on the screen of the computer 100, it is possible to remote control the studio light by clicking the mouse, keying in with keyboard or using other manners to enable the control mark to be under a planar control on the screen. Furthermore, in other non-illustrated embodiments, it is also possible to remote control the studio light by touching or pressing an input device connecting the computer, such as using a touch screen, a touchpad, a tablet or a smartphone. For example, it is possible to use not only a touch screen or a touchpad connecting the computer to directly control the wireless remote controller, but also a touch screen on a tablet or a smartphone with a remote desktop software to be a remote controller for controlling the screen on the screen of the computer to indirectly control the wireless remote controller. In such a case, when a user touches the center of the second quadrant of the preview screen by using a touch screen or keys in the coordinate, the bulb icon 420 will directly jump to the location. Alternatively, when a user presses the upper left corner of the preview screen for a long time by using a touch screen, the bulb icon 420 will move to the location step by step. In addition, although the studio lights 300a, 300b, 300c, 300d in the above-mentioned embodiments are all disclosed in disposing at the left side and the right side in front of the object to be photographed for lighting it from the front side, in other non-illustrated embodiments, each of the studio lights can also be disposing at a side of, at the rear side of, at the back side of, over or under the object to be photographed for lighting a side, the rear side, the background, the top or the bottom of the object to be photographed.

Furthermore, although the above-mentioned embodiments are all disclosed in using a computer to remote control the brightness of the studio light, it is also possible to using the computer to remote control the color temperature of the studio light in other non-illustrated embodiments. For example, the LED module 320 as shown in FIG. 1 can be composed of a substrate (not shown) and two kinds of LED diodes with different color temperatures, such as 3000K and 5600K, arranged on the substrate. Thus, the color temperature of the light will be 3000K when the computer remote controls the studio light to only light on the LED diodes with 3000K color temperature. In contrast, the color temperature of the light will be 5600K when the computer remote controls the studio light to only light on the LED diodes with 5600K color temperature. Alternatively, the color temperature of the light will be 4300K when the computer remote controls the studio light to light on all of the LED diodes.

It should be noted that the value of the track bars as shown in FIG. 6 to FIG. 9 all being represented from 0 to 100 is only one possible example of the present invention, not for limiting the scope of the present invention. In other non-illustrated embodiments, the value can also be preset as any possible ranges between 0 to 100 for brightness dimming, such as from 1 to 70, from 5 to 55 or from 10 to 60, or any possible ranges between 2000K to 6000K for color temperature adjustment, such as from 3000K to 6000K, from 2000K to 5600K, or from 3000K to 5600K.

FIG. 8 illustrates a block diagram of a photography system according to another embodiment of the present invention, and FIG. 9 illustrates a schematic view of shooting a cabinet by the photography system as shown in FIG. 8. Referring to FIG. 8 and FIG. 9, the photography system 1b in the present embodiment is composed of the studio lighting system 10a, two photography devices 20a, 20b and a sensor 30, wherein the studio lighting system 10a is substantially the same as that shown in FIG. 1 and omitted herein. In the present embodiment, the studio light 300 is exemplarily disposed to the upper front side of the cabinet 2. Besides, each of the two photography devices 20a, 20b exemplarily connects the computer 100 with a USB cable, wherein the photography device 20a is exemplarily used for shooting the front side of the cabinet 2, while the photography device 20b is exemplarily used for shooting the top side of the cabinet 2.

For example, the sensor 30 can be a sound sensor or a speech recognizer disposed under the ceiling and connect the computer 100 via a USB cable, an Ethernet cable or other cables for wire signal transmission. In other embodiments, the sensor 30 can connect the computer 100 via a wireless signal as well. When the sensor 30 detects a specific sound or wording, the computer 100 transmits a control signal to the photography device or the studio light. In an instance, the computer 100 can increase the brightness of the studio light 300 when a whistle sound is detected and remote control the photography device to shoot when a clapping sound is detected by the sensor 30 once a proper preset has been made. In addition, the sensor 30 can further be a motion sensor, and the computer 100 can increase the brightness of the studio light 300 when a motion of swinging arm up is detected, decrease the brightness of the studio light 300 when a motion of swinging arm down is detected, and remote control the photography device to shoot when a motion of clapping hands is detected by the sensor 30. Furthermore, in other embodiments, the sensor 30 can further be an image sensor or an image recognizer, so as to enable the computer 100 to transmit various control signals to the photography device or the studio light when specific motions, facial expressions or gestures are detected by the sensor 30.

In summary, comparing to the usage of a traditional remote controller to remote control the studio light in the prior art, the construction of the present invention using a computer to transmit a wireless signal to remote control a studio light is not only quicker and more accurate but also possible to simultaneously control several or several groups of studio lights. Besides, it is possible to not only switch on, switch off, and increase or decrease the brightness and/or the color temperature of several or several groups of the studio lights simultaneously, but also switch on or increase the brightness and/or the color temperature of one or at least a part of the studio lights when switching off or decrease the brightness and/or the color temperature of another one or at least another part of the studio lights simultaneously. Hence, it is possible to immediately find out the best appearance of the object to be photographed as requirement, such as the best wrinkle, shadow, brightness and reflection. In addition, other than clicking with a mouse, keying in with a keyboard or dragging a mouse cursor, it is also possible to remote control the studio light or the photography device by touching or pressing a touch screen, a touchpad, a tablet, a smartphone connecting the computer, or detecting voices, sounds, speeches, motions, facial expressions, gestures with a sensor.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A grouped photography studio lighting system with software-driven and simultaneous wireless dimming control, comprising:
a wireless remote controller;
a computer, including a software for controlling the wireless remote controller to transmit at least a wireless signal; and
a plurality of studio lights, each of the studio lights having a receiver for receiving the wireless signal and capable of lighting an object to be photographed according to the wireless signal, wherein the wireless remote controller is capable of switching on or increasing a parameter of at least one or at least a group of the studio lights and switching off or decreasing the parameter of at least another one or at least another group of the studio lights simultaneously when a control mark on a screen of the computer is under a planar control.

2. The grouped photography studio lighting system with software-driven and simultaneous wireless dimming control as claimed in claim 1, wherein the wireless remote controller is built in or outside the computer.

3. The grouped photography studio lighting system with software-driven and simultaneous wireless dimming control as claimed in claim 1, wherein the computer is a desktop, a laptop, a tablet or a smartphone.

4. The grouped photography studio lighting system with software-driven and simultaneous wireless dimming control as claimed in claim 1, wherein the wireless signal is radio frequency signal, Wi-Fi signal or Bluetooth signal and broadcasted by the wireless remote controller.

5. The grouped photography studio lighting system with software-driven and simultaneous wireless dimming control as claimed in claim 1, wherein the parameter is brightness or color temperature.

6. The grouped photography studio lighting system with software-driven and simultaneous wireless dimming control as claimed in claim 1, wherein each of the studio lights is a photo light or a video light.

7. The grouped photography studio lighting system with software-driven and simultaneous wireless dimming control as claimed in claim 1, wherein the planar control comprises at least one of touching, pressing, track bar sliding, clicking, keying in and cursor dragging by using an input device.

8. The grouped photography studio lighting system with software-driven and simultaneous wireless dimming control as claimed in claim 7, wherein the input device comprises a keyboard, a mouse, a touch screen, a touchpad, a tablet or a smartphone.

9. The grouped photography studio lighting system with software-driven and simultaneous wireless dimming control as claimed in claim 1, wherein each of the studio lights is preset into at least a group of front light, back light, rear light, side light, top light and bottom light for lighting the object to be photographed from different directions.

10. A photography system, comprising the grouped photography studio lighting system with software-driven and simultaneous wireless dimming control as claimed in claim 1 and at least a photography device, wherein the photography device is controlled by the computer via a wire signal or another wireless signal and capable of providing a real-time preview image on the screen.

11. The photography system as claimed in claim 10, wherein the photography device is a camera, a video recorder, a smartphone or a tablet.

12. The photography system as claimed in claim 10, wherein a number of the photography device is plural, and the computer simultaneously controls the photography devices to shoot the object to be photographed from different shooting angles via a wire signal or another wireless signal.

13. The photography system as claimed in claim 10, further comprising a sensor, wherein the computer connects the sensor via a wire signal or another wireless signal, and controls the photography device according to at least one of sounds, voices, speeches, motions, facial expressions and gestures detected by the sensor.

14. A photography system comprising the grouped photography studio lighting system with software-driven and simultaneous wireless dimming control as claimed in claim 1 and at least a sensor, wherein the sensor connects the computer via a wire signal or another wireless signal, and each of the studio lights is controlled according to at least one of sounds, voices, speeches, motions, facial expressions and gestures detected by the sensor.

15. The photography system as claimed in claim 14, wherein the sensor is a sound sensor, a speech recognizer, a motion sensor, an image sensor or an image recognizer.
